(19) United States
(12) Patent Application Publication
(10) Pub. No.: US 2009/0045559 A1
(43) Pub. Date: Feb. 19, 2009

(54) SWITCH HOUSING FOR GAS SPRING

(76) Inventors: Troy A. Waterman, Ionia, MI (US); Clare P. Heleski, Zeeland, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 11/837,752

(22) Filed: Aug. 13, 2007

(51) Int. Cl. F16F 9/02

(52) U.S. Cl. 267/118

(57) ABSTRACT

A switch housing is shaped to be coupled to a gas spring and includes a limit switch having a control element which is moved to actuate the limit switch when the gas spring rod moves between first and second positions. The housing includes a cylindrical aperture for receiving the body of a gas spring with one end of the aperture including an annular wall and a coupling for attaching to the rod of a gas spring. In one embodiment the housing mounts the limit switch in offset relationship to the cylindrical aperture with the control element of the switch extending into the aperture to be actuated by the body of a gas spring.

### BACKGROUND OF THE INVENTION

The present invention relates to housing for mounting a limit switch to a gas spring.

Gas springs have become commonly used for a variety of applications. For example in the automotive field, gas springs are frequently employed to assist in the raising and lowering of hatchbacks for access to the interior of a vehicle as well as for the opening and closing of vehicle hoods. Such springs are also employed in the boating industry for controlling various hatches and cabinet doors. In the furniture industry, gas springs are used to assist in opening closing or holding cabinet doors in a fixed position. In many instances, when a hatch door or other closure member is opened or closed, it is desirable to activate or inactivate a light or other electrical device. Typically such electrical devices are actuated by a separate switch mounted between the door hatch or other movable closure and the fixed vehicle body or cabinet. In such applications the door, cover or hatch itself causes the electrical device to be activated or deactivated upon opening and closing.

One spring damper design suggests integrally including a switch which is integrated into the spring damper itself U.S. Pat. No. 4,317,014 discloses a custom designed gas spring housing in which electrical conductors are integrated into the gas spring housing and extend to contacts which close when the gas spring reaches a predetermined position. Thus, although such a gas spring arrangement provides electrical contacts which can be used for activating or deactivating electrical devices associated with a closure member, it does so by requiring a custom designed and relatively expensive gas spring housing and switch contact structure, which is custom designed and manufactured for particular applications.

There exists a need for a relatively inexpensive and yet durable switch mounting construction which allows the mounting of a conventional limit switch to conventional gas springs or for retrofitting existing gas springs of conventional design with a limit switch, such that a reliable yet inexpensive switch control can be incorporated within either an existing gas spring installation to provide an electrical control signal for electrical devices actuated by the movement of the gas spring or for use with new gas spring installations where it is desired to avoid the use of separate switches incorporated into, for example, a vehicle body, a cabinet, or the like.

### SUMMARY OF THE INVENTION

The present invention satisfies this need by providing a switch housing for positioning a limit switch on a gas spring, such that movement of the gas spring actuates the limit switch to provide an electrical control signal to an electrical device which is thereby actuated upon movement of the gas spring.

A switch housing according to one aspect of the present invention includes a generally cylindrical aperture having one end which is attached to one end of the gas spring. The aperture is shaped and positioned to selectively receive the gas spring body as the gas spring is moved. The housing includes a compartment for receiving a limit switch having a control element which extends within the cylindrical aperture such that, as the gas spring body enters and exits the cylindrical aperture, the control element is moved to actuate the limit switch. In a preferred embodiment of the invention, the housing is substantially water-resistant to resist weather elements and includes indexing tabs for aligning and coupling the housing to an end coupling of a gas spring.

In one embodiment also, the housing includes a guide washer through which the gas spring rod extends to maintain the housing in alignment with the gas spring during operation. The limit switch can be a conventional commercial limit switch and housing shaped to extend over and coupled to conventional gas springs and provides a pair of electrical conductors extending from said switch and employed for controlling electrical devices, such as lights, when a cover or hatch is opened or closed.

Thus, with the housing of the present invention, a relatively inexpensive system is provided for providing electrical signals during operation of a gas spring to thereby eliminate the need for separate switches to be incorporated into the vehicle body, a cabinet, or other items with a closable cover or door which requires the use or activation of an electrical device upon opening or closing of the cover or door.

These and other features, objects and advantages of the present invention will become apparent upon reading the following description thereof together with reference to the accompanying drawings.

### BRIEF DESCRIPTION OF THE DRAWINGS

FIG. 1 is a perspective view of a gas spring and switch housing incorporating the present invention;

FIG. 2 is an enlarged side elevational view of the assembly shown in FIG. 1, shown with one side of the housing removed and with the spring in a first position of the switch contained therein;

FIG. 3 is an enlarged side elevational view of the assembly shown in FIG. 1, shown with one side of the housing removed and with the spring in a second position of activation of the switch contained therein, showing the interrelationship between the gas spring body and switch contained within the housing;

FIG. 4 is a cross sectional view of the housing shown in FIG. 2, taken along section lines IV-IV, and

FIG. 5 is a cross-sectional view of the housing shown in FIG. 3, taken along section lines V-V.

### DETAILED DESCRIPTION OF THE PREFERRED EMBODIMENT

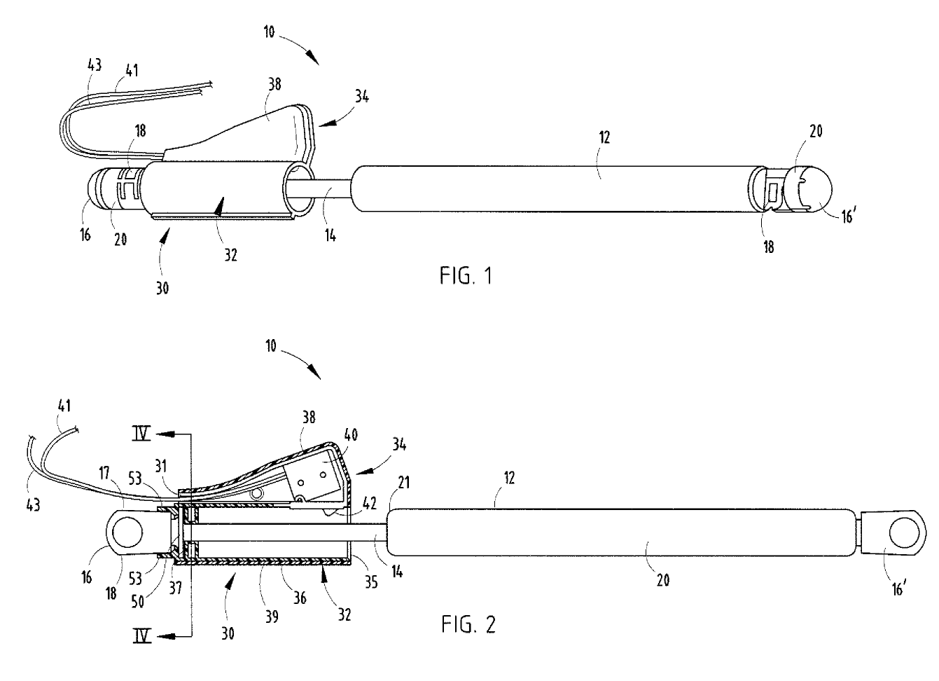

Referring initially to FIG. 1, there is shown a gas spring 10 embodying the present invention which includes a cylindrical body 12 housing a rod 14 extending therefrom. A quick disconnect coupling 16, of the type disclosed in U.S. Pat. No. 7,124,684, the disclosure of which is incorporated herein by reference, is integrally molded onto the end of rod 14 (FIG. 5). The opposite end of cylinder 12 likewise is coupled to a quick disconnect coupling 16′ of the same construction to allow the gas spring to be mounted between conventional ball posts, as disclosed in the '684 patent, and easily removed by the rotation of the locking handle 18, which raises a locking spring 20 in each of the couplings 16 for removal of the gas spring from the object to which it is attached.

Typically, the gas spring will have one end 16′ coupled to, for example, the hatch of a vehicle and the opposite end 16 coupled to the vehicle body in an area adjacent the hatch. One such spring 10 is employed on opposite sides of the hatch to assist in the opening and closing in a controlled manner of the vehicle hatch. Similarly, spring 10 can be used between cabinet doors and cabinet bodies to assist in opening cabinets in the furniture environment or hatches on boats or storage compartments in airplanes and universally in almost any application in which the controlled movement of a movable member with respect to a fixed member is desired.

In many such applications, when a hatch cover or door is being opened, it is desired to activate an electrical device, such as a light, an alarm chime, or other electrically actuated device which is activated upon movement of the hatch cover or door. When a gas spring 10 is employed, the rod 14 is extended from or retracted within the body 12 of gas assist spring 10. Spring 10 can be of conventional construction, such as disclosed in U.S. Pat. No. 4,045,008.

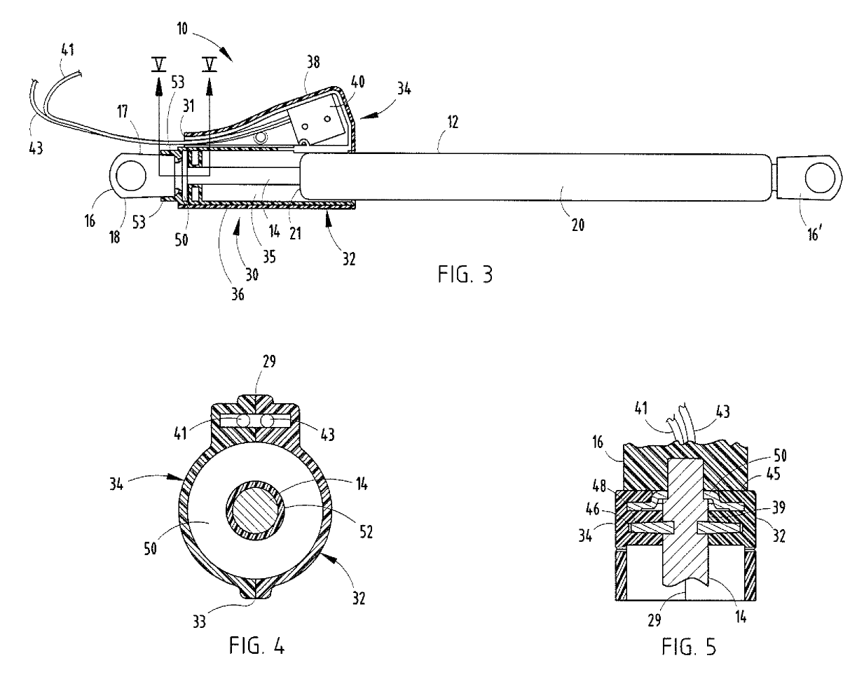

In order to provide an electrical signal from the operation of gas spring 10, the switch housing 30 of the present invention is employed and mounted to one end, such as the end of rod 14, as illustrated in FIGS. 1-3. The switch housing 30 comprises a first housing half 32, shown in FIGS. 2 and 3, covered by a second housing half 34 (FIG. 1), which is substantially identical and symmetrical to half 32 and is secured to housing half 32 by means of ultrasonic welding, bonding or the like, around an upper seam 29 and a lower seam 33 (FIG. 4). The switch housing has a generally cylindrical main body 36 defining a cylindrical aperture 35 having an internal diameter sufficiently large for receiving the outer cylindrical diameter of the end 21 of the body 12 of cylinder 20, as illustrated in FIG. 3.

The housing 30 includes an integral side compartment 38 which extends adjacent cylindrical section 36 and is generally triangular in cross-section, as seen in FIGS. 2 and 3, for receiving therein a micro limit switch 40 having an actuating element 42, which extends into the cylindrical aperture 35 of the cylindrical section 36 of housing 30, such that the end 21 of cylinder 20 will, when rod 14 is retracted within cylinder 20, engage the actuating element 42, as illustrated in FIG. 3. This moves element 42 toward the body of switch 40 thereby actuating the switch between a first state and a second state. Depending upon the control effect desired, switch 40 can be a normally open switch, when in the position shown in FIG. 2, and closed to make contact between conductors 41 and 43 coupled to switch 40 when closed, as shown in FIG. 3. Alternatively, the switch can be designed so that it is normally closed when in the position shown in FIG. 2 and opens upon contact with the control element 42, as shown in FIG. 3.

Housing sections 32 and 34 define an annular end wall 45 (FIG. 5) behind which is an annular socket 37 formed by semi-annular mating sections 46 spaced from wall 45 in each half 32 and 34 for defining the washer receiving and captive holding socket for an annular washer 50 with a curved profile, which is captively held within socket 37 and has an opening 52 for engaging the rod 14 to absorb any side loads which may be placed upon the switch housing during actuation of gas spring 10. The housing sections 32 and 34 also define a second polymeric annular wall 39 spaced from wall 45 defining a second socket 46 for receiving a keeper clip 48 (FIG. 5) engaging a radial recess in rod 14 in axially spaced relationship to washer 50 for holding the end of rod 14 to housing 30.

The end 31 (FIGS. 2 and 3) of housing 30 integrally includes a pair of flat outwardly extending tabs 53 (FIGS. 2, 3, and 5) formed by symmetrical halves in each of the sections 32 and 34, which engage the flat surfaces 17 and 18 on connector 16 to align and index the switch housing 30 with quick disconnect coupling 16 and fix the relationship between the housing 30 and coupling 16. Housing halves 32 and 34 can be made of suitable polymeric material, such as polycarbonate, ABS, 33% glass-filled nylon, or the like, and conductors 41 and 43 extend through the end of housing section 38 and may be sealed by a suitable sealing compound to a create a water-resistant housing and switch assembly.

While in the preferred embodiment housing 30 is mounted to the end of rod 14 adjacent coupling 16 of gas spring 10 (i.e., the extended end of rod 14), it likewise could be mounted to end 21 of cylinder 20 with switch receiving sections 38 configured to position the control element 42 of switch 40 in a position to be engaged by fitting 16 as the rod 14 extends from or retracts into cylinder 20. In any configuration, the housing and switch assembly 30 is configured to be fixedly attached to a gas strut and position and enclose a limit switch which engages a movable element on the gas spring, such that movement of the gas spring between retracted and extended positions actuates the switch and an electrical control signal can be employed for activating an electrical device.

It will become apparent to those skilled in the art that various modifications to the preferred embodiment of the invention as described herein can be made without departing from the spirit or scope of the invention as defined by the appended claims.

The invention claimed is:

1. A switch housing for a gas spring comprising:
a housing having an aperture formed therein, with an opening for receiving the body of a gas spring;
said housing including an end for securing to a rod extending from a gas spring for mounting said housing to a gas spring;
said housing further including a switch-receiving section adjacent said aperture; and
a limit switch with a control arm extending into said aperture, such that when the housing extends over the body of a gas spring, the control element of said switch is moved to change the state of actuation of said switch.

2. The switch housing as defined in claim 1 wherein said housing includes an annular end wall opposite said opening through which a gas spring rod can extend.

3. The switch housing as defined in claim 2 wherein said housing further includes an annular socket adjacent said end wall for mounting a washer in said housing.

4. The switch housing as defined in claim 3 wherein said housing further includes at least one indexing tab extending from said end wall for positioning said housing in a predetermined relationship to a rod end coupling.

5. The switch housing as defined in claim 4 and further including a snap ring mounted to said housing in axially spaced relationship to said washer for securing said housing to a rod end of a gas spring.

6. The switch housing as defined in claim 5 wherein said housing is made of a polymeric material.

7. A switch housing and a gas spring comprising:
a gas spring having a cylindrical body and a rod extendable from said body;
a housing having a cylindrical aperture formed therein, with an opening at one end for receiving said body of said gas spring;
said housing including an end for secured to an end of said rod extending from said gas spring for mounting said housing to said gas spring; and
said housing further including a limit switch with a control arm extending into said cylindrical aperture, such that when said rod is retracted such that said body of said gas spring, extends into said aperture said control element of said switch is moved to change the state of actuation of said switch.

8. The apparatus as defined in claim 7 wherein said housing includes an annular end wall opposite said opening through which said gas spring rod extends.

9. The apparatus as defined in claim 8 wherein said housing further includes an annular socket adjacent said end wall for mounting a rod supporting washer in said housing.

10. The apparatus as defined in claim 9 and further including a quick disconnect coupling at an end of said rod and wherein said housing includes at least one indexing tab extending from said end wall for positioning said housing in a predetermined relationship to said coupling.

11. The apparatus as defined in claim 10 and further including a snap ring mounted to said housing in axially spaced relationship to said washer for securing said housing to said rod

12. The apparatus as defined in claim 11 wherein said housing is made of a polymeric material.

13. A switch and housing for a gas spring comprising:
a housing for coupling to a gas spring; and
a limit switch positioned in said housing and having a control element which is moved to change the state of actuation of said switch when a rod of a gas spring moves between first and second positions.

14. The switch and housing as defined in claim 13 wherein said housing includes an annular end wall through which a gas spring rod can extend.

15. The switch and housing as defined in claim 14 wherein said housing further includes an annular socket adjacent said end wall for mounting a rod supporting washer in said housing.

16. The switch and housing as defined in claim 15 wherein said housing further includes a pair of spaced indexing tabs extending outwardly from said end wall for positioning said housing in a predetermined relationship to a rod end coupling.

17. The switch and housing as defined in claim 16 and further including a snap ring mounted to said housing in axially spaced relationship to said washer for securing said housing to a rod end of a gas spring.

18. The switch and housing as defined in claim 17 wherein said housing is made of a polymeric material.

19. The switch and housing as defined in claim 18 wherein said switch is sealed in said housing and includes electrical leads extending therefrom.

20. The switch and housing as defined in claim 19 wherein said housing includes a cylindrical aperture for receiving the body of a gas spring and further includes a section offset from said aperture for receiving a limit switch with said control element extending into said aperture to actuate said limit switch when the body of a gas spring enters said aperture.
